(19) United States
(12) Patent Application Publication
(10) Pub. No.: US 2010/0252405 A1
(43) Pub. Date: Oct. 7, 2010

(54) Electronic device having a polymer light emitting module

(76) Inventor: Chih-Kang Chen, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/461,698

(22) Filed: Aug. 21, 2009

(30) Foreign Application Priority Data
Apr. 1, 2009 (CN) 200910130354.7

(51) Int. Cl. H01H 9/00

(52) U.S. Cl. 200/314

(57) ABSTRACT

An electronic device includes a housing for housing a polymer light emitting module therein. The polymer light emitting module includes a plurality of polymer light emitting units formed on a membrane substrate. The housing has a plurality of transparent areas corresponding respectively to the polymer light emitting units of the polymer light emitting module such that the polymer light emitting units are capable of emitting light through the transparent areas in the housing.

### CROSS-REFERENCE TO RELATED APPLICATION

This application claims priority of Chinese Application No. 200910130354.7, filed on Apr. 1, 2009.

### BACKGROUND OF THE INVENTION

1. Field of the Invention

The invention relates to an electronic device, more particularly to an electronic device having a polymer light emitting module that serves as a backlight source.

2. Description of the Related Art

A conventional keyboard device includes a plurality of light emitting diodes (LEDs) corresponding to key caps. Each LED is operable to emit light such that a user can easily verify position of a corresponding key cap. However, since the LEDs have point light source characteristics, light guiding elements are required to guide light emitted by the LEDs so as to obtain an even light distribution, thereby resulting in higher costs. Due to the use of the light guiding elements, light intensity decay easily occurs, thereby resulting in insufficient brightness.

Another conventional keyboard device includes a backlight source composed of a plurality of organic light emitting diodes (OLEDs) that have surface light source characteristics. However, OLEDs have a relatively complicated semiconductor fabrication process.

### SUMMARY OF THE INVENTION

Therefore, an object of the present invention is to provide an electronic device having a polymer light emitting module that can provide a surface light source.

According to the present invention, an electronic device comprises:

a polymer light emitting module including a flexible membrane substrate, and a plurality of polymer light emitting units formed on the membrane substrate; and

a housing for housing the polymer light emitting module therein, the housing having a plurality of transparent areas corresponding respectively to the polymer light emitting units of the polymer light emitting module such that the polymer light emitting units are capable of emitting light through the transparent areas in the housing.

The electronic device of the present invention can be embodied as one of a keyboard device and a notebook computer. When the electronic device is embodied as a keyboard device, the housing includes a plurality of key caps each formed with a corresponding one of the transparent areas. When the electronic device is embodied as a notebook computer, the housing includes a cover part for receiving the polymer light emitting module therein. The cover part has an outer plate formed with the transparent areas.

The polymer light emitting module is capable of providing a surface light source serving as a backlight source without light guiding elements required in a conventional backlight source including conventional light emitting diodes, thereby resulting in a relatively lower cost as compared to the conventional backlight source.

Furthermore, as compared to a backlight source including organic light emitting diodes, the polymer light emitting module can be fabricated by printing such that the polymer light emitting module can be easily fabricated at a relatively low cost. Furthermore, since the membrane substrate of the polymer light emitting module is flexible, the polymer light emitting module facilitates wide application.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded, fragmentary perspective view showing the first preferred embodiment of an electronic device according to the present invention;

FIG. 2 is a schematic top view showing a polymer light emitting module of the first preferred embodiment;

FIG. 3 is a schematic circuit block diagram illustrating the first preferred embodiment;

FIG. 4 is a perspective view showing the second preferred embodiment of an electronic device according to the present invention;

FIG. 5 is a schematic top view showing a polymer light emitting module of the second preferred embodiment; and

FIG. 6 is a fragmentary, partly schematic sectional view showing an assembly of a display panel, a cover part and the polymer light emitting module of the second preferred embodiment.

### DETAILED DESCRIPTION OF THE PREFERRED EMBODIMENTS

Before the present invention is described in greater detail, it should be noted that like elements are denoted by the same reference numerals throughout the disclosure.

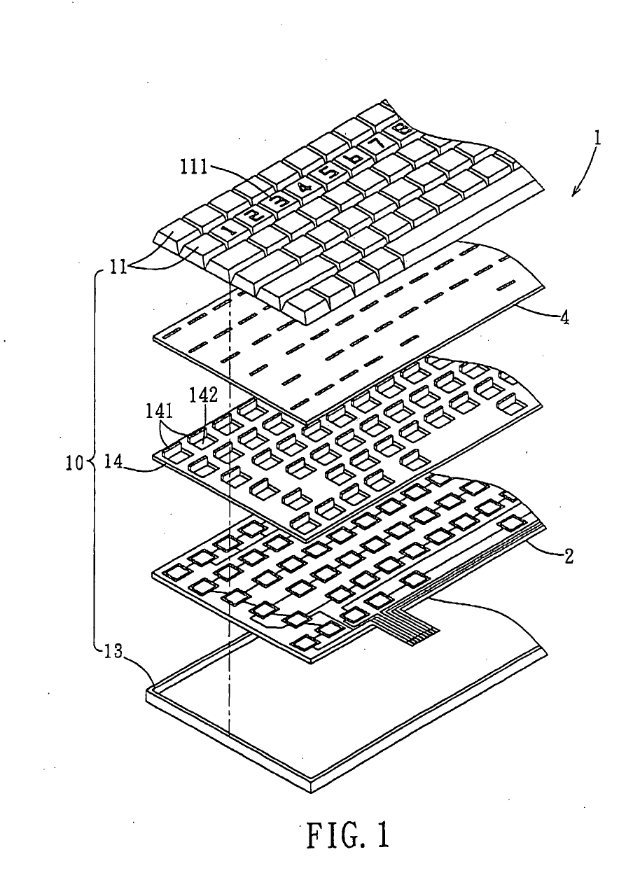

Referring to FIGS. 1 and 3, the first preferred embodiment of an electronic device 1 according to the present invention is shown. In this embodiment, the electronic device 1 is embodied as a keyboard device, and includes a housing 10, a polymer light emitting module 2, a transparent flexible printed circuit board 4, and a control module 3.

The housing 10 has a plurality of transparent areas 111. In this embodiment, the housing 10 includes a base 13, a supporting plate 14, and a plurality of key caps 11. The supporting plate 14 is disposed in the base 13, has a plurality of upwardly extending supporting portions 141 for supporting respectively the key caps 11 thereon, and is formed with a plurality of through holes 142 corresponding respectively to the key caps 11. In other embodiments, the supporting plate 14 can be transparent without the through holes. Each key cap 11 is formed with a corresponding transparent area 111 (a part of the transparent areas 111 is shown in FIG. 1) that is in the form of one of a numeral, a character, a symbol and a pattern so as to indicate specific function thereof. In other embodiments, each transparent area 111 can be a transparent portion of the corresponding key cap 11.

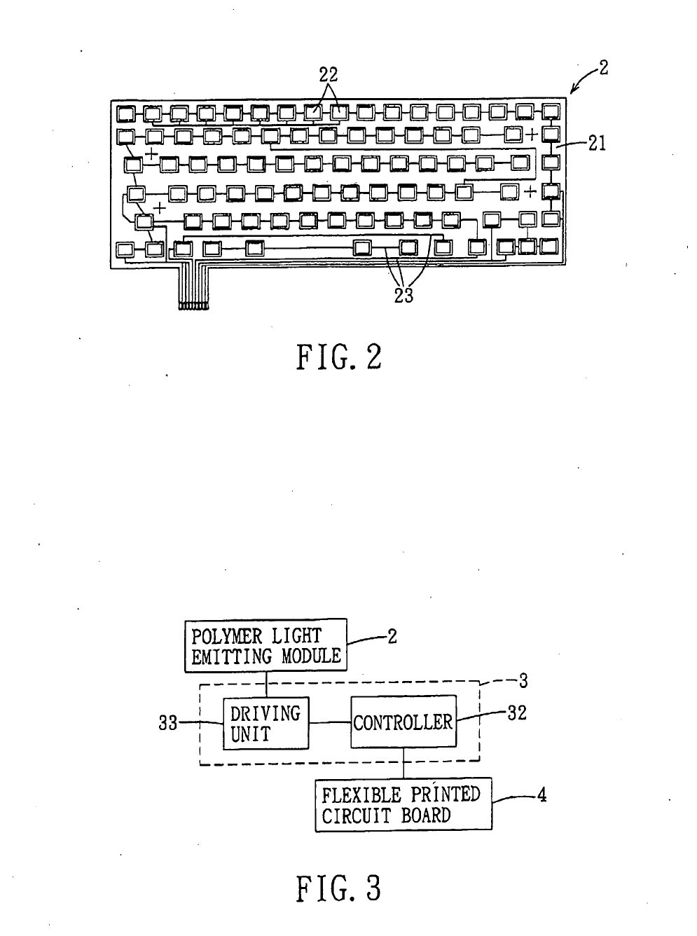

The polymer light emitting module 2 is received in the housing 10 and is disposed between the base 13 and the supporting plate 14 in this embodiment. Referring further to FIG. 2, the polymer light emitting module 2 includes a flexible membrane substrate 21, a plurality of polymer light emitting units 22 formed on the membrane substrate 21 and corresponding respectively to the key caps 11 such that the polymer light emitting units 22 are capable of emitting light through the through holes 142 in the supporting plate 14 and the transparent areas 111, and a conductive wiring 23 formed on the membrane substrate 21 and coupled to the polymer light emitting units 22. Each polymer light emitting unit 22 is a multi-layer structure that generally has a hole injection electrode made of indium tin oxide (ITO) serving as an anode, a hole transport layer, a polymer light emitting layer, an electron transport layer, and an electron injection electrode serving as a cathode. Since the feature of this invention does not reside in the configuration and fabrication of the polymer light emitting units 22, which are known to those skilled in the art, details of the same are omitted therein for the sake of brevity.

In this embodiment, the polymer light emitting module 2 can serve as a backlight source. The polymer light emitting units 22 are arranged as the key caps 11 such that functions of the key caps 11 can be clearly indicated by the transparent areas 111 in the key caps 11 when the polymer light emitting units 22 are activated to emit light. Furthermore, each polymer light emitting unit 22 is made of a specific polymer light emitting material, and is capable of emitting light having a predetermined color such that the key caps 11 are configured into a plurality of key regions having different colors.

The flexible printed circuit board 4 is received in the housing 10, is disposed between the key caps 11 and the supporting plate 14, and permits the supporting portions 141 of the supporting plate 14 therethrough.

The control module 3 is disposed in the housing 10, and includes a driving unit 33 coupled to the polymer light emitting module 2, and a controller 32 coupled to the driving unit 33 and the flexible printed circuit board 4 for controlling the driving unit 33 to drive the polymer light emitting module 2. In this embodiment, the controller 32 controls the driving unit 33 to drive the polymer light emitting module 2 based on operation of the key caps 11. Alternatively, the controller 32 controls the driving unit 33 to drive the polymer light emitting module 2 in a random manner, regardless of operation of the key caps 11. For example, when one key cap 11, such as a Shift key, is pressed, the controller 32 controls the driving unit 33 to drive a corresponding polymer light emitting unit 22, which is aligned with the transparent portion area 111 in the Shift key, to emit light upon detecting press of said one key cap 11. As such, a user can confirm press of the Shift key through the lighted Shift key. In another example, when one key cap 11, such as a Ctrl key, is pressed, the controller 32 controls the driving unit 33 to drive a corresponding polymer light emitting unit 22, which is aligned with the transparent portion area 111 in the Ctrl key, to emit light upon detecting press of said one key cap 11, and subsequently, to drive neighboring polymer light emitting units 22 to emit light. However, control performed by the control module 3 is not limited to the aforesaid examples.

The polymer light emitting module 2 can provide a highly even surface light source. Therefore, when the polymer light emitting module 2 serves as a backlight source of the keyboard device 1, additional light guiding elements are not required, and uneven light distribution or light intensity decay can be avoided.

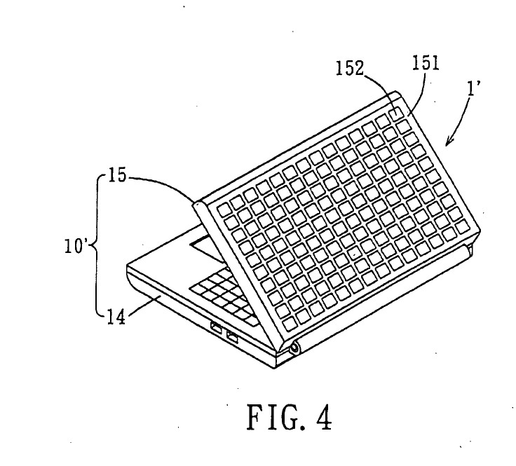

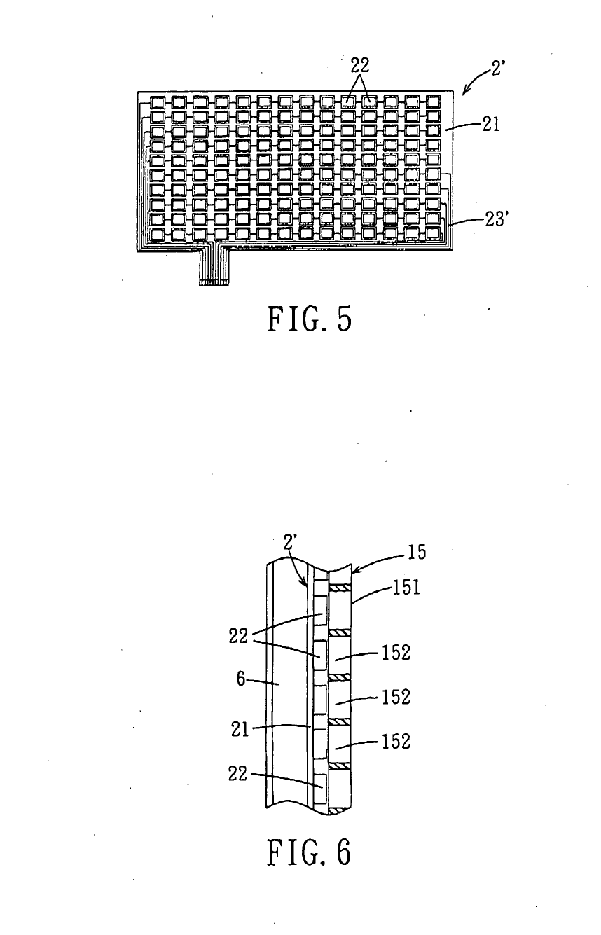

FIGS. 4 to 6 illustrate the second preferred embodiment of an electronic device 1′ according to this invention, which is a modification of the first preferred embodiment. In this embodiment, the electronic device 1′ is embodied as a notebook computer.

In this embodiment, the housing 10′ includes a main housing part 14, and a cover part 15 connected pivotally to the main housing part 14 and having an inner side mounted with a display panel 6, as shown in FIG. 6. The cover part 15 has an outer plate 151 formed with a plurality of through holes 152 that are arranged in the form of an array and that serve as the transparent areas.

The polymer light emitting module 2′ is received in the cover part 15 of the housing 10′ and is disposed between the display panel 6 and the outer plate 151. In this embodiment, the polymer light emitting module 2′ includes the membrane substrate 21, the polymer light emitting units 22 corresponding respectively to the through holes 152 in the outer plate 151 such that the polymer light emitting units 22 are capable of emitting light through the through holes 152, and the conductive wiring 23′ is coupled to the polymer light emitting units 22. In other embodiments, each through hole 152 in the outer plate 151 of the cover part 15 is filled with a transparent material, thereby preventing dust or liquid from coming into the cover part 15.

In this embodiment, the controller 32 of the control module 3 is operable to control the driving unit 33 based on a desired one of various driving programs pre-stored therein to drive the polymer light emitting module 2′ such that the polymer light emitting module 2′ is driven to show a desired pattern, such as a dynamic wavy pattern, for decorative purposes. Alternatively, the polymer light emitting module 2′ can be driven to show a static pattern including at least one of a picture and a character. Therefore, the electronic device 1′ has a vivid and attractive appearance.

In sum, since the polymer light emitting module 2, 2′ can provide a surface light source, the polymer light emitting module 2, 2′ is adapted to serve as a backlight source without additional light guiding elements required in a light source including conventional light emitting diodes, thereby resulting in a relatively lower cost as compared to the aforesaid light source. Furthermore, as compared to a backlight source including organic light emitting diodes each having a glass substrate, the polymer light emitting module 2, 2′ can be fabricated by printing such that the polymer light emitting module 2, 2′ can be easily fabricated at a relatively low cost. Furthermore, since the membrane substrate 21 of the polymer light emitting module 2, 2′ is flexible, the polymer light emitting module 2, 2′ facilitates wide application. On the other hand, due to the presence of the control module 3, the polymer light emitting module 2, 2′ can be driven to show various patterns.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electronic device comprising:
a polymer light emitting module including a flexible membrane substrate, and a plurality of polymer light emitting units formed on said membrane substrate; and
a housing for housing said polymer light emitting module therein, said housing having a plurality of transparent areas corresponding respectively to said polymer light emitting units of said polymer light emitting module such that said polymer light emitting units are capable of emitting light through said transparent areas in said housing.

2. The electronic device as claimed in claim 1, wherein;
said electronic device is a keyboard device; and
said housing includes a plurality of key caps formed respectively with said transparent areas.

3. The electronic device as claimed in claim 2, further comprising a transparent flexible printed circuit board received in said housing and disposed between said key caps and said polymer light emitting module.

4. The electronic device as claimed in claim 2, wherein each of said transparent areas is in the form of one of a numeral, a character, a symbol and a pattern.

5. The electronic device as claimed in claim 1, wherein:
said electronic device is a notebook computer; and
said housing includes a main housing part, and a cover part connected pivotally to said main housing part for receiving said polymer light emitting module therein, said cover part having an outer plate formed with said transparent areas.

6. The electronic device as claimed in claim 5, wherein said cover part of said housing is formed with a plurality of through holes that serve as said transparent areas.

7. The electronic device as claimed in claim 1, further comprising a control module disposed in said housing, and including a driving unit coupled to said polymer light emitting module, and a controller coupled to said driving unit for controlling said driving unit to drive said polymer light emitting module.

8. The electronic device as claimed in claim 1, wherein each of said polymer light emitting units is made of a specific polymer light emitting material, and is capable of emitting light having a predetermined color
